(19) United States
(12) Patent Application Publication
(10) Pub. No.: US 2008/0225453 A1
(43) Pub. Date: Sep. 18, 2008

(54) Breaker control system using power frequency carrier

(75) Inventor: Yuan-Yu Huang, Taipei City (TW)

Correspondence Address: TROXELL LAW OFFICE PLLC, SUITE 1404, 5205 LEESBURG PIKE, FALLS CHURCH, VA, 22041, US

(73) Assignee: HANSDER ENGINEERING CO., LTD., Taipei City (TW)

(21) Appl. No.: 11/723,204

(22) Filed: Mar. 16, 2007

(51) Int. Cl. H02H 3/00

(52) U.S. Cl. 361/64

(57) ABSTRACT

More than one high-pressure facility is controlled. A first power frequency carrier unit of the high-pressure facility is connected with a second power frequency carrier unit of a monitoring device through the indoor power unit. Thus, the high-pressure facility can be monitored and controlled by the monitoring device remotely.

### FIELD OF THE INVENTION

The present invention relates to a control system; more particularly, relates to controlling at least one high-pressure facility remotely by connecting a first power frequency carrier unit and a second power frequency carrier unit through an indoor power unit.

### DESCRIPTION OF THE RELATED ART

A factory is generally equipped with engine oil pipes, vacuum chambers, air chambers, gas burners, etc. for convenience of operation.

Owing to these pipes, chambers and burners, areas of high pressure are formed in the factory and engineers has to enter these area to fix them once accident happens or to maintain them after a period of time of use. But, accident is accident; it is not predictable. The engineer has to enter these areas to know what happens and try to fix them after shutting the abnormal high-pressure facilities. If the abnormal high-pressure facility is so worn out that it can not be shut immediately or in advance and the engineer has already entered into the area, the engineer may be fallen into a great danger in the high pressure environment Hence, the prior art does not fulfill users' requests on actual use.

### SUMMARY OF THE INVENTION

The main purpose of the present invention is to control at least one high-pressure facility remotely by connecting a first power frequency carrier unit and a second power frequency carrier unit through an indoor power unit

To achieve the above purpose, the present invention is a breaker control system using power frequency carrier, comprising at least one high-pressure facility having a first power frequency carrier unit; and a monitoring device having a control member and a display unit, where the monitoring device is connected with a second power frequency carrier unit; and the second power frequency carrier unit is connected with the first power frequency carrier unit through an indoor power unit. Accordingly, a novel breaker control system using power frequency carrier is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the frame-work of the preferred embodiment according to the present invention;

FIG. 2 is the block view showing the preferred embodiment;

FIG. 3 is the block view showing the first and the second power frequency carrier unit;

FIG. 4 is the view showing the state of use of the preferred embodiment; and

FIG. 5 is the block view showing the state of use of the preferred embodiment.

### DESCRIPTION OF THE PREFERRED EMBODIMENT

The following description of the preferred embodiment is provided to understand the features and the structures of the present invention.

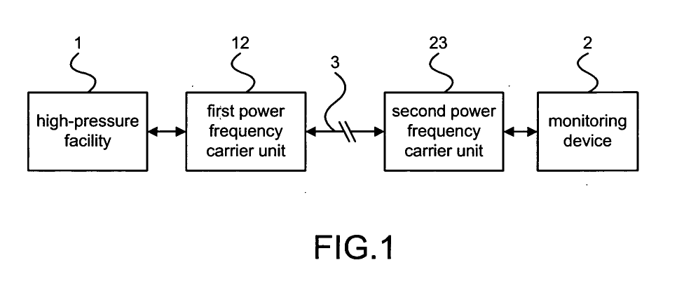

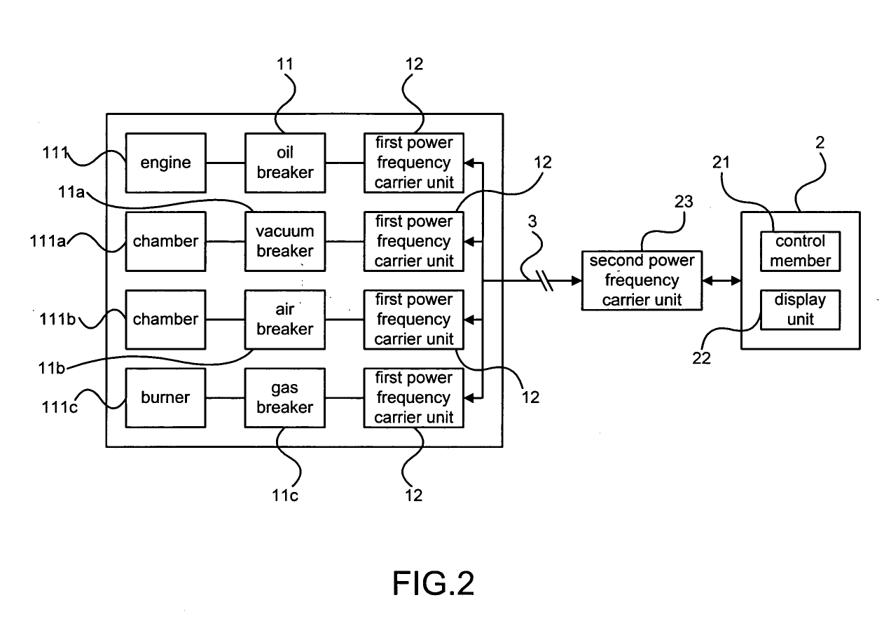

Please refer to FIG. 1 and FIG. 2, which are a framework view and a block view showing a preferred embodiment according to the present invention. As shown in the figures, the present invention is a breaker control system using power frequency carrier, comprising at lease one high-pressure facility 1 and a monitoring device 2.

The at least one high-pressure facility 1 is an oil breaker 11 connected with an engine 111; a vacuum breaker 11a connected with a chamber 111a; an air breaker 11b connected with a chamber 111b; an air breaker 11b connected with a chamber 111b; a gas breaker 11c connected with a burner 111c; or a combination of the above components coordinated simultaneously or separately according to a requirement. And the oil breaker 11, the vacuum breaker 11a, the air breaker 11b and the gas breaker 11c each is connected with a first power frequency carrier unit 12.

The monitoring device 2 comprises a control member 21 and a display unit 22, where the monitoring device 2 is connected with a second power frequency carrier unit 23; and the second power frequency carrier unit 23 is connected with the first power frequency carrier unit 12 through an indoor power unit 3. Thus a novel breaker control system using power frequency carrier is obtained.

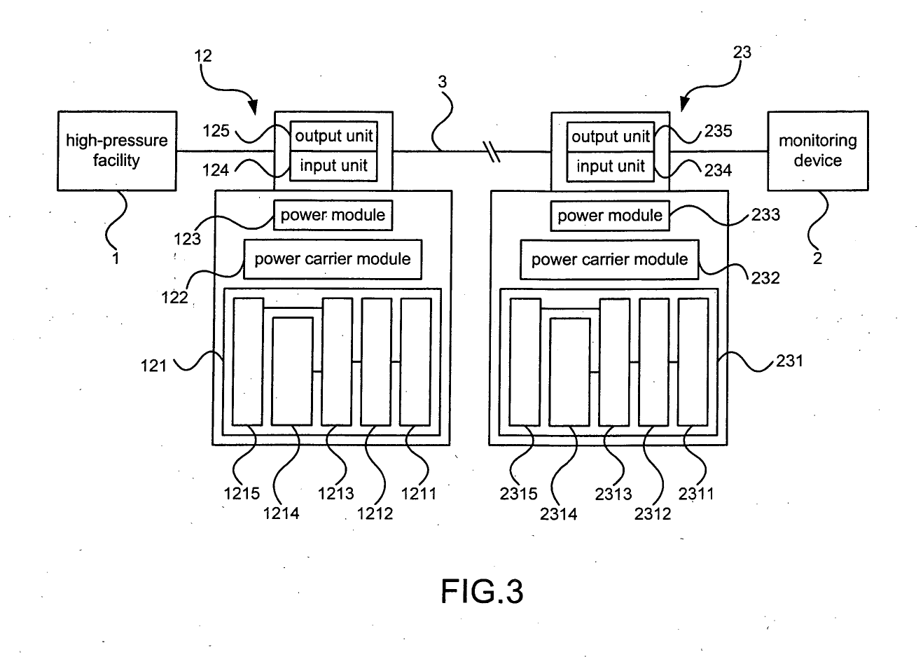

Please refer to FIG. 3, which is a block view showing a first power frequency carrier unit and a second power frequency carrier unit. As shown in the figure, a first power frequency carrier unit 12 comprises a single-chip control module 121; a power carrier module 122 having a transmission rate of 1200 BPS (bit per second); a power module 123 supplying power for the single-chip control module 121 and the power carrier module 122; an input unit 124; and an output unit 125, where the single-chip control module 121 comprises an output controller 1211, a relay 1212, a control unit 1213 a communication interface 1214 and an input receiver 1215.

A second power frequency carrier unit 23 comprises a single-chip control module 231; a power carrier module 232 having a transmission rate of 1200 BPS; a power module 233 supplying power for the single-chip control module 231 and the power carrier module 232; an input unit 234; and an output unit 235, where the single-chip control module 231 comprises an output controller 2311, a relay 2312, a control unit 2313, a communication interface 2314 and an input receiver 2315.

The control unit 1213,2313 either in the first power frequency carrier unit 12 or the second power frequency carrier unit 23 is a 8051 single-chip as a processing unit with a good inner structure, whose working frequency is up to 16 MHz together with a 4k size of electrically programmable and erasable ROM (Read Only Memory) together with eight input pins and eight output pins Each of the first and the second relay 1212,2312 is located at the output pins of the 8051 single-chip to quarantine the circuit for securing and ensuring the operation of the 8051 single-chip. Each 8051 single-chip contains a full-duplex communication interface inside, which are the first and the second communication interfaces 1214,2314. Each communication interface 1214,2314 is an RS232 interface to simultaneously transfer and receive data from outside. The operational signals in the 8051 single-chip are on a TTL (transistor-transistor-logic) level (0 voltage set as logic 0; +5 voltage set as logic 1) and each communication interface 1214,2314 is a serial communication interface to transfer or receive data in a form of bit series.

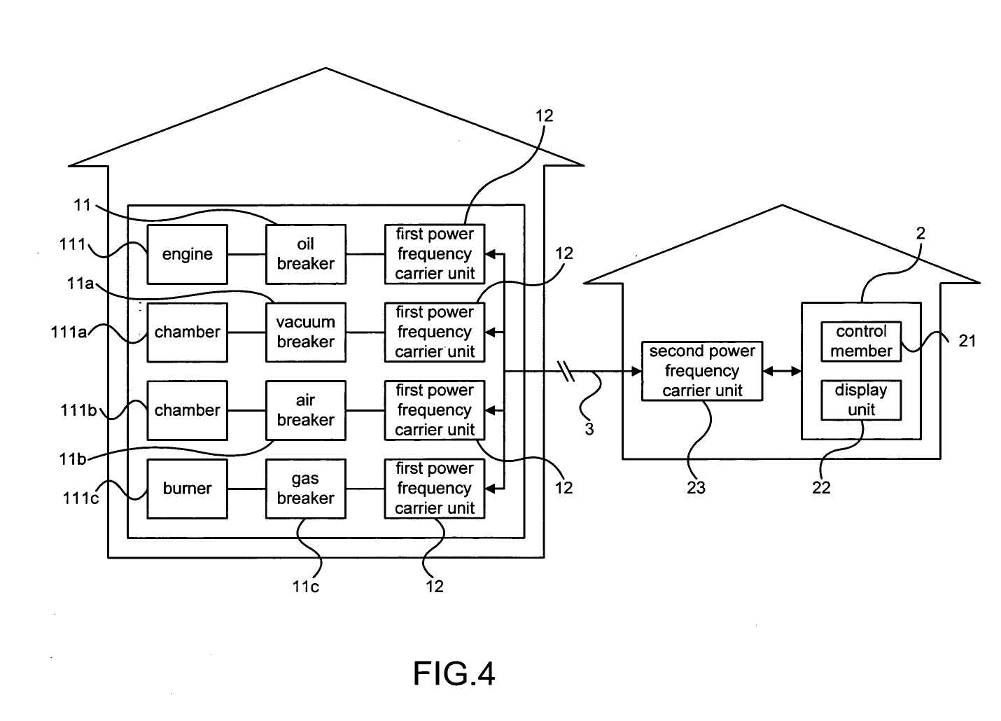

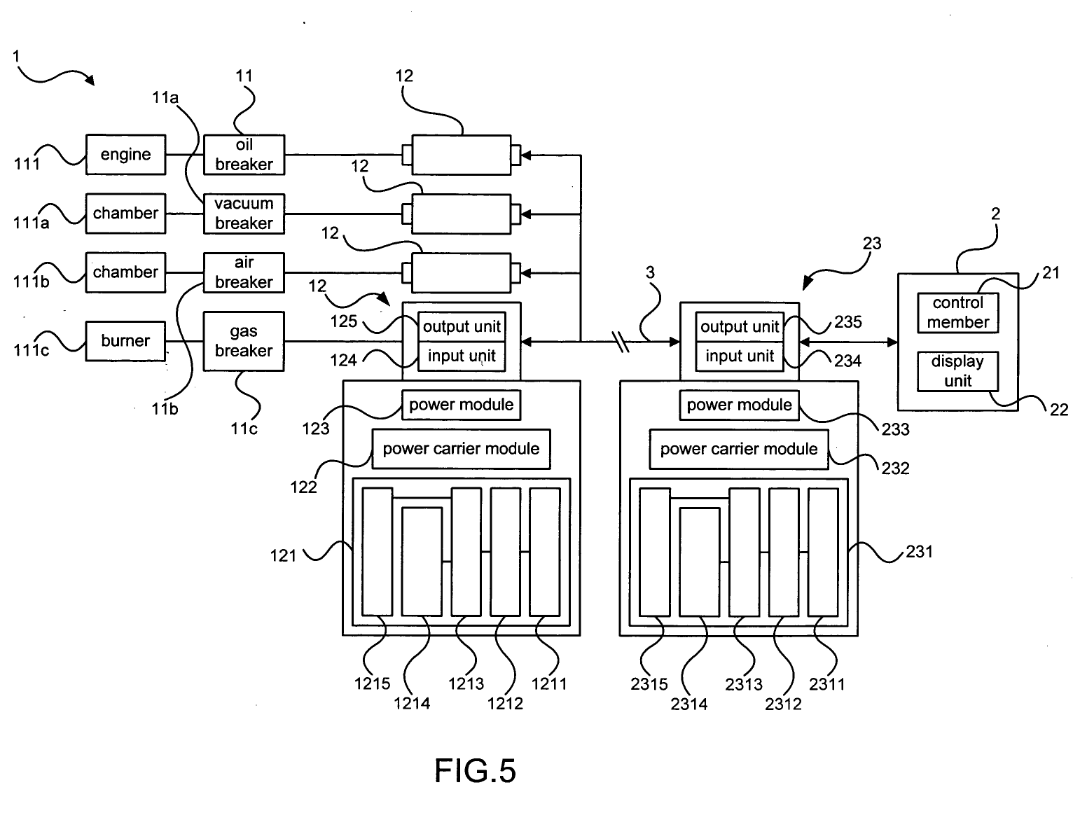

Please refer to FIG. 4 and FIG. 5, which are a view showing a state of use and a block view showing the state of use of the preferred embodiment. As shown in the figures, the present invention is applied in a factory 4 having high-pressure facilities 1, such as an oil breaker 11a vacuum breaker 11a, an air breaker 11b and a gas breaker 11c. A monitoring device 2 is equipped in a remote control room 5 for the factory 4. A first power frequency carrier unit 12 of the high-pressure facility 1 and a second power frequency carrier unit 23 of the monitoring device 2 are plugged in sockets of an indoor power unit 3 to connect the first power frequency carrier unit 12 and the second power frequency carrier unit 23.

When using the high-pressure facility 1, the oil breaker 11, the vacuum breaker 11a, the air breaker 11b or the gas breaker sends a state-of-use signal to the second power frequency carrier unit 23 by the first power frequency carrier unit 12 through the indoor power unit 3 to be displayed on a display unit 22. When the high-pressure facility 1 transfers the signal, the first frequency carrier unit 12 integrates and encodes the signal through a single-chip control module 121, a power carrier module 122 and a power module 123; a transmission mode and speed are detected and set by the single-chip control module 121; and the signal is transferred by an output unit 125 of the first power frequency carrier unit 12 through the indoor power unit 3. Thus the sate-of-use signal of the high-pressure facility 1 is transferred to the second power frequency carrier unit 23 of the monitoring device 2. An input unit 234 of the second power frequency carrier unit 23 receives the signal and the signal are decoded through a single-chip control module 231, a power carrier module 232 and a power module 233. Then the status of the high-pressure facility 1 is determined and is outputted from an output unit 235 to be shown on the display unit 22.

When the high-pressure facility 1 operates well, no abnormal signal is outputted; and a normal signal is sent from the first power frequency carrier unit to the second power frequency carrier unit to display ‘normal’ on the display unit 22. An engineer monitoring or maintaining the facilities in the control room 5 is thus informed of the wellness of the high-pressure facility 1.

When an abnormal situation happens to the high-pressure facility 1, the high-pressure facility 1 receives an abnormal signal for the oil breaker 11, the vacuum breaker 11a, the air breaker 11b or the gas breaker 11c. The abnormal signal is then sent from the first power frequency carrier unit 12 to the second power frequency carrier unit 23 to be displayed on the display unit 22. An engineer monitoring or maintaining the facilities in the control room 5 is thus in formed of the abnormal situation of the oil breaker 11, the vacuum breaker 11a, the air breaker 11b or the gas breaker 11c; and the engineer responds to the abnormal situation of the high-pressure facility in the mean time by shutting some breaks or all breaks through the control member 21. By doing so, a remote control is obtained to shut the oil breaker 11, the vacuum breaker 11a, the air breaker 11b or the gas breaker 11c in advance so that the engineer maintains the high-pressure facility safely.

To sum up, the present invention is a breaker control system using power frequency carrier, where, by connecting a first power frequency carrier unit and a second power frequency carrier unit through an indoor power unit, at least one high-pressure facility is control led remotely.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A breaker control system using power frequency carrier, comprising:
at least one high-pressure facility, said high-pressure facility having a first power frequency carrier unit; and
a monitoring device, said monitoring device having a control member and a display unit, said monitoring device being connected with a second power frequency carrier unit, said second power frequency carrier unit being connected with said first power frequency carrier unit through an indoor power unit.

2. The system according to claim 1,
wherein said high-pressure facility is an oil breaker connected with an engine and a first power frequency carrier unit.

3. The system according to claim 1,
wherein said high-pressure facility is a vacuum breaker connected with a chamber and a first power frequency carrier unit.

4. The system according to claim 1,
wherein said high-pressure facility is an air breaker connected with a chamber and a first power frequency carrier unit.

5. The system according to claim 1,
wherein said high-pressure facility is a gas breaker connected with a burner and a first power frequency carrier unit.

6. The system according to claim 1,
wherein said first power frequency carrier unit and said second power frequency carrier unit each comprises a single-chip control module, a power carrier module, a power module, an output unit and an input unit.

7. The system according to claim 6,
wherein said power carrier module has a transmittal baud rate of 1200 BPS (bits per second).

8. The system according to claim 6,
wherein said single-chip control module comprises an input receiver, an output controller, a control unit, a communication interface and a relay.

9. The system according to claim 8,
wherein said control unit is a 8051 single-chip.

10. The system according to claim 8,
wherein said control unit has a working frequency of 16 MHz.

11. The system according to claim 8,
wherein said communication interface is an RS232 interface.
